(19) United States
(12) Patent Application Publication
(10) Pub. No.: US 2024/0128833 A1
(43) Pub. Date: Apr. 18, 2024

(54) SYSTEMS AND METHODS FOR PROVIDING WOBBLE REDUCTION IN GALVANOMETERS

(71) Applicant: Novanta Corporation, Bedford, MA (US)

(72) Inventor: Kurt Sidor, Plaistow, NH (US)

(21) Appl. No.: 18/379,853

(22) Filed: Oct. 13, 2023

Related U.S. Application Data
(60) Provisional application No. 63/416,106, filed on Oct. 14, 2022.

(51) Int. Cl. H02K 7/04; F16F 1/12; F16J 15/3248; F16J 15/3284; H02K 7/08; H02K 7/12

(52) U.S. Cl. CPC H02K 7/04; F16F 1/12; F16J 15/3248; F16J 15/3284; H02K 7/083; H02K 7/12

(57) ABSTRACT

A limited rotation motor system is disclosed that includes a stator within a housing, a rotor rotatably coupled within the stator by a first bearing system at a proximal end and a second bearing system at a distal end, each of said first bearing system and said second bearing system being coupled at an inner side thereof to the rotor and being coupled at an outer side thereof to the housing, a compression system applying a compressive force between the first bearing system and the second bearing system in an axial direction, and a damping system adjacent any of the first bearing system and the second bearing system, said damping system providing that divergent forces resulting from the compressive force that diverge from the axial direction are absorbed by the damping system

### PRIORITY

The present application claims priority to U.S. Provisional Patent Application No. 63/416,106 filed Oct. 14, 2022, the disclosure of which is hereby incorporated by reference in its entirety.

### BACKGROUND

The invention generally relates to motor system and relates in particular to limited rotation motor systems.

Limited rotation motor systems (e.g., galvanometer systems) may be used in galvanometer-based optical scanners. Galvanometer-based optical scanners were invented in the 19^{th} century. for many years, their use was mostly limited to scientific applications. since the invention of the laser, they have become increasingly used in a growing number of industrial, scientific, medical, and entertainment applications.

Many of these applications demand that the optical scanner be able to perform at increasing levels of speed and accuracy to meet improved throughput and performance requirements. In order to meet these more stringent requirements, materials for their construction were chosen to make the scanners faster and higher performance. Typically, materials were chosen to be lighter and stiffer. These materials would raise the resonant frequencies to levels higher than the applications would easily excite. Ever increasing demands on optical scanner throughput have created faster scanning systems that more easily excite their natural resonant frequencies, either by directly driving the product at its resonance or near it by operating at fractional increments (or harmonics) of the resonant frequency.

When the resonant frequency is excited, it can cause the optical scanner to move its scanning spot outside the desired range of axial controlled motion. This unwanted motion has earned itself the name of wobble describing its cross axis oscillatory vibration.

Applications using optical scanners continue to demand high performance at ever increasing speeds. In order to meet these needs, wobble, needs to be controlled, either by reducing it to an acceptable level or by eliminating it completely. For many users of optical scanners, this is critical for them to be able to make and use optical scanning systems successfully and to remain competitive in the marketplace. There remains a need for further reducing wobble in galvanometer-based optical systems.

### SUMMARY

In accordance with an aspect, the invention provides a limited rotation motor system that includes a stator within a housing, a rotor rotatably coupled within the stator by a first bearing system at a proximal end and a second bearing system at a distal end, each of said first bearing system and said second bearing system being coupled at an inner side thereof to the rotor and being coupled at an outer side thereof to the housing, a compression system applying a compressive force between the first bearing system and the second bearing system in an axial direction, and a damping system adjacent any of the first bearing system and the second bearing system, said damping system providing that divergent forces resulting from the compressive force that diverge from the axial direction are absorbed by the damping system.

In accordance with another aspect, the invention provides a limited rotation motor system that includes a stator within a housing, a rotor rotatably coupled within the stator by a first bearing system at a proximal end and a second bearing system at a distal end, each of said first bearing system and said second bearing system being coupled at an inner side thereof to the rotor and being coupled at an outer side thereof to the housing, a compression system applying a compressive force between the first bearing system and the second bearing system in an axial direction, and a damping system between the rotor and the housing and providing that divergent forces resulting from the compressive force that diverge from the axial direction are absorbed by the damping system.

In accordance with a further aspect, the invention provides a method of operating a limited rotation motor. The method includes providing a stator within a housing, providing a rotor rotatably coupled within the stator by a first bearing system at a proximal end and a second bearing system at a distal end, each of said first bearing system and said second bearing system being coupled at an inner side thereof to the rotor and being coupled at an outer side thereof to the housing, applying a compressive force between the first bearing system and the second bearing system in an axial direction, and damping divergent forces resulting from the compressive force that diverge from the axial direction by absorbing the divergent forces with an elastomeric component between the rotor and the housing.

### BRIEF DESCRIPTION OF THE DRAWINGS

The following description may be further understood with reference to the accompanying drawings in which:

FIG. 1 shows an illustrative diagrammatic view of a limited rotation motor system in accordance with an aspect of the present invention;

FIG. 2 shows an illustrative diagrammatic enlarged view of a proximal end of the system of FIG. 1;

FIG. 3 shows an illustrative diagrammatic enlarged view of a distal end of the system of FIG. 1;

FIG. 4 shows an illustrative diagrammatic view of forces applied in the system of FIG. 1;

FIG. 5 shows an illustrative diagrammatic enlarged view of a distal end of a system in accordance with an aspect of the invention that includes an axial-compressed O-ring;

FIG. 6 shows an illustrative diagrammatic enlarged view of a distal end of a system in accordance with an aspect of the invention that includes a cross-sectionally L-shaped elastomeric material;

FIG. 7 shows an illustrative diagrammatic enlarged view of a distal end of a system in accordance with an aspect of the invention that includes a cross-sectionally L-shaped elastomeric material that is provided external to the bearing system;

FIG. 8 shows an illustrative diagrammatic enlarged view of a distal end of a system in accordance with an aspect of the invention that includes a thrust washer and plural O-rings;

FIG. 9 shows an illustrative diagrammatic enlarged view of a distal end of a system in accordance with an aspect of the invention that includes an annular elastomeric material bonded to an inner surface of the inner race of the bearing system; and

FIG. 10 shows an illustrative diagrammatic enlarged view of a distal end of a system in accordance with an aspect of the invention that includes an annular elastomeric material bonded to an outer surface of the inner race of the bearing system.

The drawings are shown for illustrative purposes only.

### DETAILED DESCRIPTION

The design of a galvanometer-based optical scanner consists of a stationary member as well as a rotating member. The rotating member is held within the stationary member by means of low friction rotational mechanisms restricting the motion to within a desired axis of revolution. Due to the rigidity of the materials commonly used, the system can have significant mechanical resonant frequencies. These resonances can be excited by the intended motions of the rotating member. If left undamped, these resonant vibrations can cause unwanted motions out of the plane of intended motion. By proper application of the use of materials with vibration damping properties in the construction of an optical scanning system, a scanning system can be built that can significantly reduce these vibrations to a level that will not detract from the intended accurate performance of the system. A goal of the design of the system is to reduce or eliminate unwanted cross axis resonant motion in galvanometer-based optical scanners to the point where it no longer degrades the intended accuracy of the system.

A magnetic driven optical scanner consists of a rotational element constrained within a housing. The example shown uses a Face to Face ball bearing preload to accurately hold and constrain the rotational elements motion into an accurately controlled axis of rotation.

The preload force is created by compressing spring against the outer race of the rear ball bearing. This axial force is split between axial and radial component forces through the angular interface of the bearings raceway and the spherical balls contained in it. The compression of the ball's transfers some of the force radially driving the balls into the edges of the raceway removing ‘slop’ and taking up internal mechanical clearances within the ball bearing structure. The axial component transfers its force through the length of the rotor where it passes similarly through a second ball bearing in a symmetric arrangement to the first.

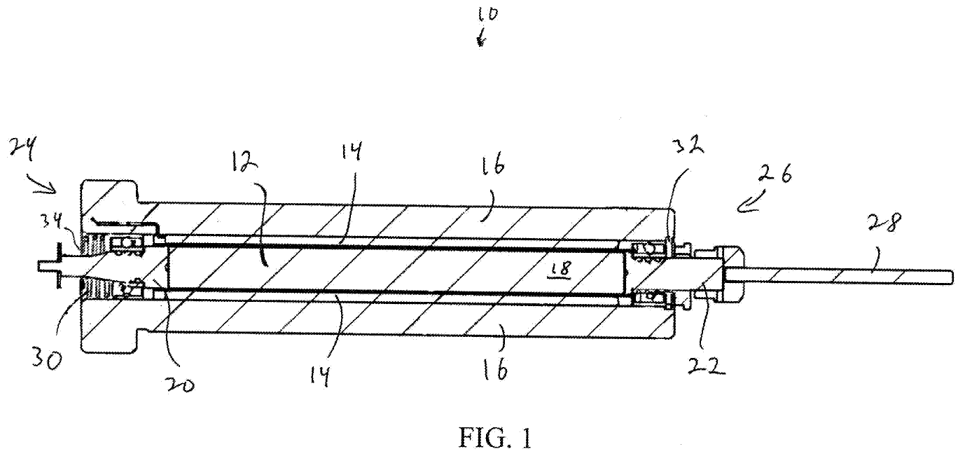

FIG. 1 for example, shows a limited rotation motor system 10 in accordance with an aspect of the present invention that includes a rotor 12 within a stator 14 inside a housing 16. The rotor includes a magnet 18 contained between a proximal end cap 20 at a proximal end 24, and a distal end cap 22 at a distal end 26. A tool such as a mirror 28 is coupled to the distal end cap 26.

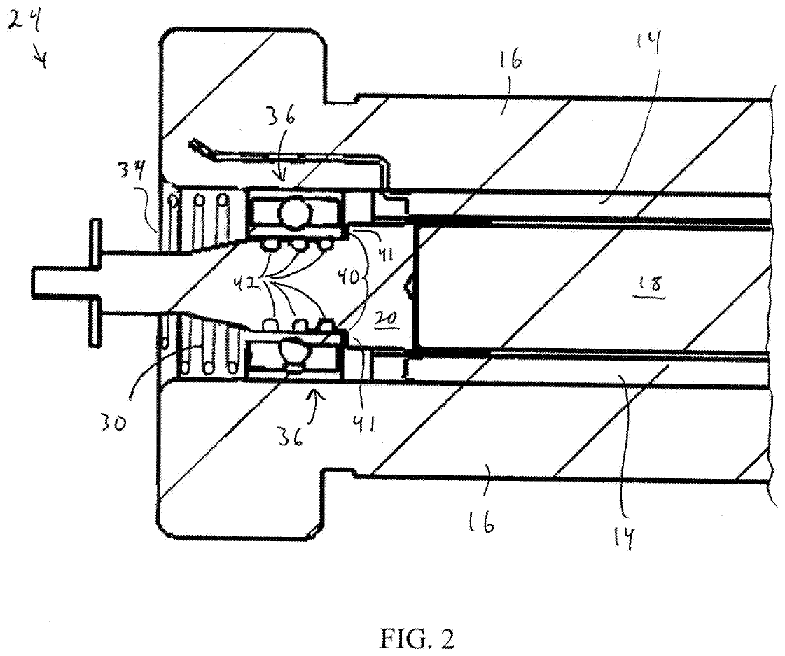

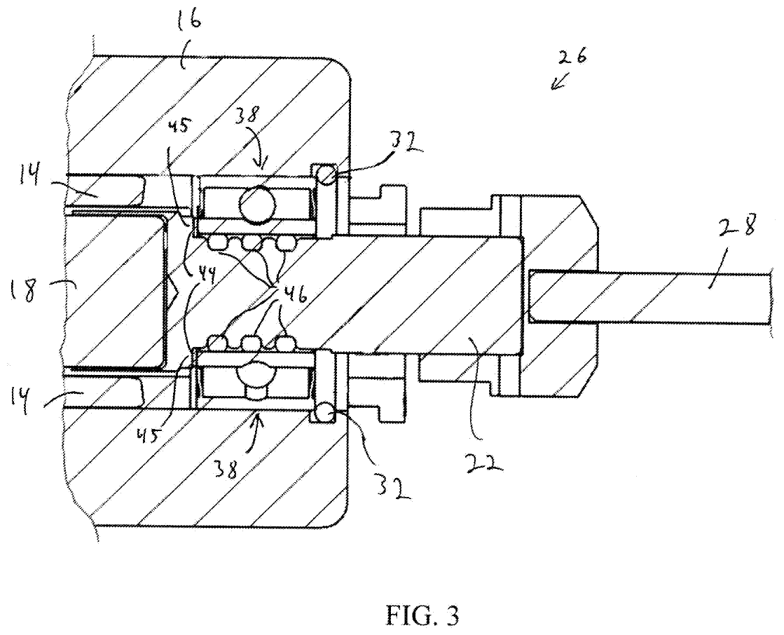

With further reference to FIG. 2 (which shows an enlarged view of the proximal end) and FIG. 3 (which shows an enlarged view of the distal end), each end cap is coupled to the housing 16 via one of a proximal bearing system 36 and a distal bearing system 38. The proximal end 24 includes a compression spring 30 held by a closure plate 34 that applies a compressive force against a retaining ring 32 at the distal end. At the distal end, the axial forces pushing through the distal end of the distal bearing system 38 are held back by retaining ring 32 held in the housing 16. This is the design of an optical scanner constructed using two deep grove radial ball bearings preloaded in a ‘Face to Face’ arrangement. Typically, all the materials used in this compression stack are rigid, solid materials.

This construction technique typically creates an optical scanning system of two predominately rigid, solid members: the rotating element 12 and the stationary member 14 (e.g., a densely wrapped set of conductive coiled wire). Each of these assemblies has resonant frequencies determined by the structure's geometric layout, materials, and constraining forces. Typically, these resonant frequencies are desired to be higher than frequencies that would occur during the operation of the product. However, under certain circumstances it is difficult to avoid exciting these resonances by the designed operation of the scanner.

These resonant frequency oscillations can cause the scanning system to vibrate and cause motion to occur outside of the desired single axis of revolution. In the optical scanning business, this undesired motion has earned itself the nickname of wobble. The mirror element of the optical scanner is intended to rotate purely about the scanner's axis of rotation in a manner that creates an angularly addressable position tracing out motion within one plane creating a straight line. When the mirror/shaft assembly vibrates at or near the resonant frequency, the resonant frequency can excite the flat mirror in a cantilever mode causing the scanned area of the optical field to now be at a position other than at the desired perpendicular spot within the plane of rotation. In a side cross sectional view of the mirror, this motion would appear similar to a diving board bending under a swimmer about to jump off of it. This undesired up and down motion in the optical scanner system is known as wobble. If this uncontrolled motion is undesirable for system performance, then it must be mitigated.

With reference again to FIG. 2, the proximal end 24 further includes a compliant thrust washer 40 between the proximal bearing system 36 and the proximal end cap 20, as well as one or more compliant O-rings 42 also between the proximal bearing system 36 and the proximal end cap 20. Similarly, with reference again to FIG. 3, the distal end 24 further includes a compliant thrust washer 44 between the distal bearing system 38 and the distal end cap 22, as well as one or more compliant O-rings 46 also between the distal bearing system 38 and the distal end cap 22.

With the addition of the above compliant materials to the preload force-stack, the excitation of the rotating members resonance can be diminished. The preload force transfers through the compliant thrust washers 40, 44 on its way from the shaft assembly into the inner race of the front ball bearing, as shown in the close-up views of FIGS. 2 (showing the proximal end) and 3 (showing the distal end). The compliant radial members (O-rings) are added between the shaft assembly 12 and the inner surface of the bearing systems' inner diameters. Slightly compressed O-rings are used in this example to hold the front diameter of the rotating shaft assembly centered within the inner diameter of the bearing. By including a clearance between the rigid surfaces of the bearing and the shaft, resonant vibrations in the radial direction can be minimized by allowing microscopic motion to occur at this interface and be absorbed by the compliant material properties of the O-rings 42, 46 rather than through a rigidly bonded shaft to bearing contact. Silicone may also be chosen as a good material for use in the compliant thrust washer 40, 44 and for the radially compressed O-rings 42, 46. The O-rings 42, 46 may be maintained under radial pressure in the limited rotation motor system 10.

The compliant thrust washers 40, 44 of FIGS. 2 and 3 each bear against a shoulder (41, 45 respectively) of an end cap 20, 22. Although the shoulders 41, 45 are provided in the axial direction, they are radially offset from the central regions of the end caps against which the compressive force (F_{c}) is provided. FIG. 3 shows a diagrammatic view of the distal end of the system 10, showing the compression thrust washers 40, 44 and compression O-rings 42, 44 (three each) between the rotor 12 and the housing 16 on the inner sides of the bearing systems 36, 38. The axial compression in the force stack is therefore not compromised, while the divergent forces are at least partially absorbed by the compliant thrust washers 40, 44. Similarly, the O-rings 42, 46 are radially offset from the central regions of the end caps against which the compressive force (F_{c}) is provided. The axial compression in the force stack is again therefore not compromised, while the divergent forces are also at least partially absorbed by the compressed O-rings 42, 46.

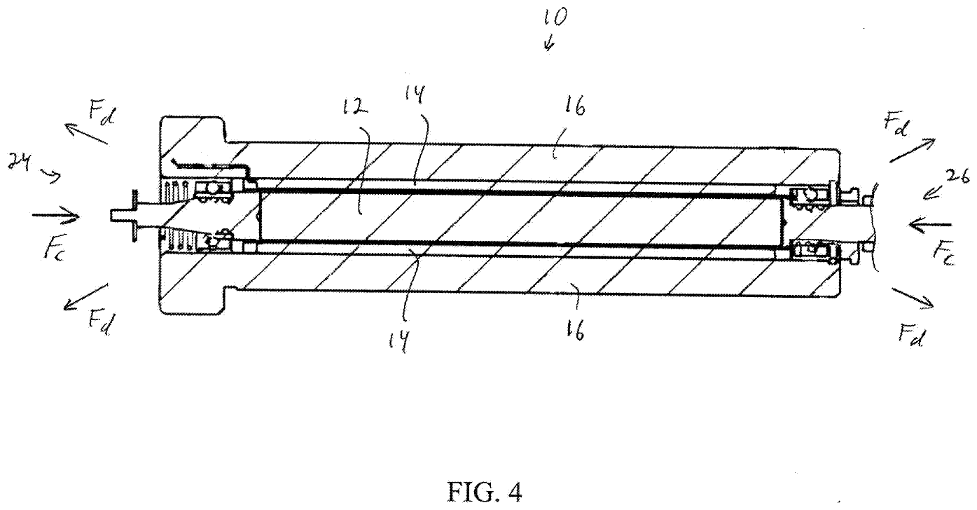

As shown in FIG. 4, the compressive force (F_{c}) of the compression spring 30 against the retaining ring (32 shown in FIG. 3) may result in divergent forces (F_{d}) that diverge from the axial direction. These divergent forces are absorbed by the compression system of the invention that includes, in accordance with an aspect, compliant force washers and compliant radial members such as O-rings.

The enhancement of this O-ring feature for the purpose of vibration reduction by increasing the number of O-rings 42, 46 used and the clearance between bearing and shaft diameter, does not negatively impact the compression of the rigidity of the system in the axial direction. By adding this compliant material, microscopic vibrations in the rotating shaft assembly are provided a place to be absorbed. By allowing this vibration to be absorbed by a material with dampening properties, the amplitude of the resonant vibrations can be reduced to an acceptable level or eliminated.

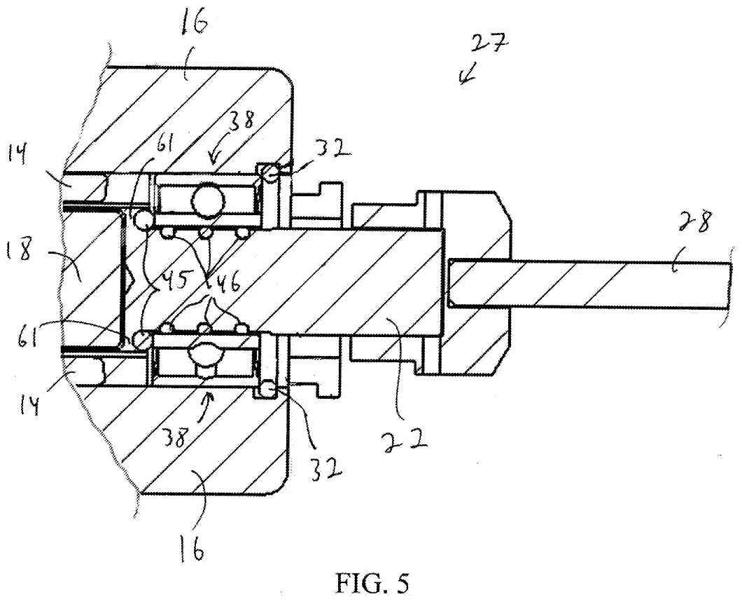

FIG. 5 shows a distal end 27 of a limited rotation motor system in accordance with a further aspect of the invention that includes an axial-compressed O-ring 45 in place of a thrust washer (of the system of FIGS. 1-3). The limited rotation motor system similarly includes the rotor 12 with the stator 14 inside the housing 16. The rotor includes the magnet 18 contained between proximal and distal end caps (distal end cap 22 is shown), with the mirror 28 mounted thereto. The O-rings 46 are radially offset from the central region of the end cap against which the compressive force (F_{c}) is provided. The O-rings 45, 46 are provided on an inner surface of the bearing system 38. The axial compression in the force stack is again therefore not compromised, while the divergent forces are also at least partially absorbed by the compressed O-rings 46. The O-rings 46 may be compressed, and may be provided as one, two or three O-rings (as shown). The compressed O-ring 45 is mounted against an axial shoulder 61 of the distal end cap 22.

Again, although the shoulder 61 is provided in the axial direction, it is radially offset from the central region of the end cap 22 against which the compressive force (F_{c}) is provided. The axial compression in the force stack is therefore not compromised, while the divergent forces are at least partially absorbed by the axial compressed O-ring 45.

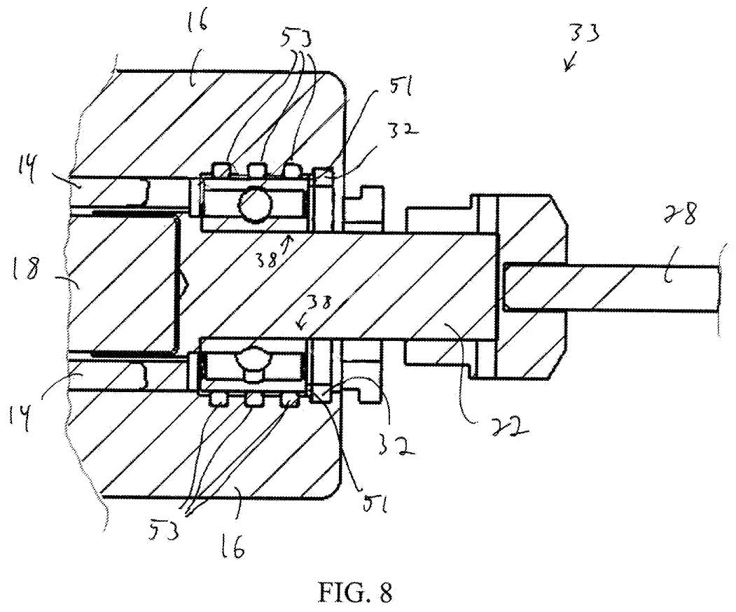

Any number of compression O-rings may be used, including for example, one, two or three O-rings (as shown) at each end of the limited rotation motor system. Further, the O-rings of FIGS. 1-4 are shown adjacent the inner races of the bearing systems 36, 38 in contact with the end caps 20, 22. In accordance with further aspects, the O-rings may be positioned radially outward such that they are adjacent the outer races of the bearing systems in contact with the housing 16 (as shown below with reference to FIG. 8). Any number of compression O-rings may be used, including for example, one, two or three O-rings (as shown) at each end of the limited rotation motor system. Further, the O-rings of FIGS. 1-4 are shown adjacent the inner races of the bearing systems 36, 38 in contact with the end caps 20, 22. In accordance with further aspects, the O-rings may be positioned radially outward such that they are adjacent the outer races of the bearing systems in contact with the housing 16 (as shown below with reference to FIG. 8). The proximal end of the limited rotation motor system may similarly include radial O-rings (e.g., 46) as well as axial compressed O-ring (e.g., 45) against a shoulder on the proximal end cap.

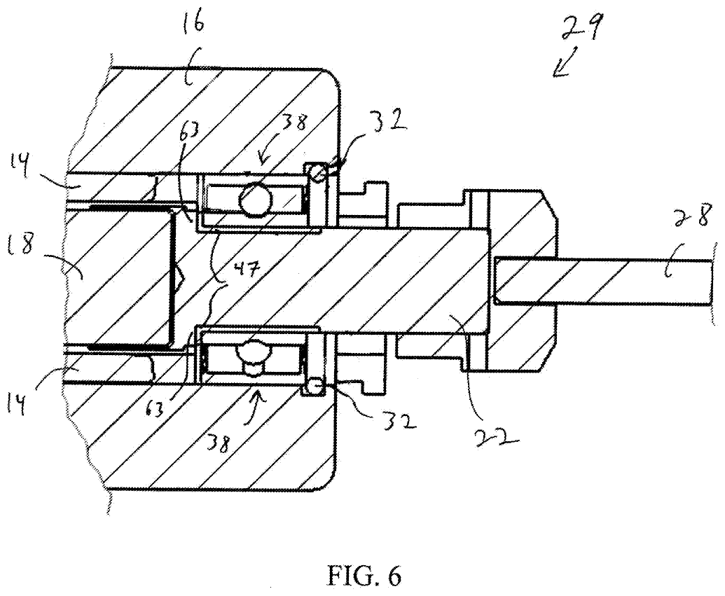

FIG. 6 shows a distal end 29 of a limited rotation motor system in accordance with a further aspect that includes a cross-sectionally L-shaped elastomeric material 47 in place of the thrust washer and axial O-rings (of the system of FIGS. 1-4). The elastomeric material 47 with the L-shaped cross-section is provided on the inside of the bearing against the shaft as shown in FIG. 6. This feature could be a molded part installed as shown or formed in place between the shaft and bearing, or an over-molded feature on the surface of the shaft. The limited rotation motor system similarly includes the rotor 12 with the stator 14 inside the housing 16. The rotor includes the magnet 18 contained between proximal and distal end caps (distal end cap 22 is shown), with the mirror 28 mounted thereto. The cross-sectionally L-shaped elastomeric material is radially offset from the central region of the end cap against which the compressive force (F_{c}) is provided. The axial compression in the force stack is again therefore not compromised, while the divergent forces are also at least partially absorbed by the cross-sectionally L-shaped elastomeric material 47, which provides axial and radial absorption. The cross-sectionally L-shaped material is mounted against an axial shoulder 63 of the distal end cap 22. Again, although the shoulder 63 is provided in the axial direction, it is radially offset from the central region of the end cap 22 against which the compressive force (F_{c}) is provided. The cross-sectionally L-shaped elastomeric material is provided on an inner surface of the bearing system 38. The axial compression in the force stack is therefore not compromised, while the divergent forces are at least partially absorbed by the cross-sectionally L-shaped material 47. The proximal end of the limited rotation motor system may similarly include cross-sectionally L-shaped elastomeric material (e.g., 47) against a shoulder on the proximal end cap.

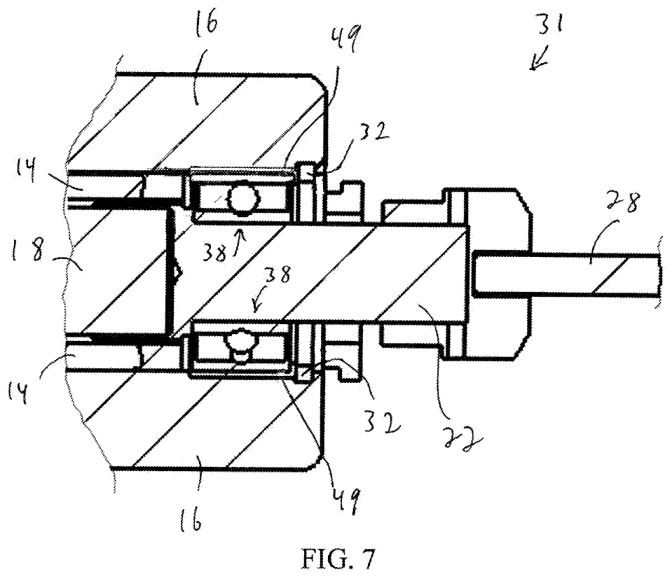

FIG. 7 shows a distal end 31 of a limited rotation motor system in accordance with a further aspect that includes a cross-sectionally L-shaped elastomeric material 49 that is provided on an outer surface of the bearing system 38, with the short length on the distal side of the bearing system 38. The limited rotation motor system similarly includes the rotor 12 with the stator 14 inside the housing 16. The rotor includes the magnet 18 contained between proximal and distal end caps (distal end cap 22 is shown), with the mirror 28 mounted thereto. The cross-sectionally L-shaped elastomeric material 49 is radially offset (even outside the bearing system) from the central region of the end cap against which the compressive force (F_{c}) is provided.

The axial compression in the force stack is again therefore not compromised, while the divergent forces are also at least partially absorbed by the cross-sectionally L-shaped elastomeric material 49, which provides axial and radial absorption. The axial compression in the force stack is therefore not compromised, while the divergent forces are at least partially absorbed by the cross-sectionally L-shaped material 49. The proximal end of the limited rotation motor system may similarly include cross-sectionally L-shaped elastomeric material (e.g., 49) mounted similarly. The L-shaped cross section of elastomer 49 of FIG. 7 is positioned on the outside of the bearing against the housing 16. This feature could be a molded part installed has shown or formed in place between the shaft and bearing, or an over-molded feature on the surface of the shaft.

FIG. 8 shows a distal end 33 of a limited rotation motor system in accordance with a further aspect that includes a thrust washer 51 mounted against an axially distal end of the bearing system 38, as well as one or more (e.g., one, two or three) O-rings 53 (e.g., circular or polygonal cross sectionally shaped) mounted on the outer race of the bearing system 38. The thrust wash 51 and O-rings 53 are both provided on an outer surface of the bearing system 38. In particular, the thrust washer 51 is positioned between the side wall of the bearings outer race and the retaining ring 32. The limited rotation motor system similarly includes the rotor 12 with the stator 14 inside the housing 16. The rotor includes the magnet 18 contained between proximal and distal end caps (distal end cap 22 is shown), with the mirror 28 mounted thereto. O-rings 53 are radially offset (even outside the bearing system) from the central region of the end cap against which the compressive force (F_{c}) is provided. The axial compression in the force stack is again therefore not compromised, while the divergent forces are also at least partially absorbed by the elastomeric material 51 and O-rings 53, which provide axial and radial absorption. The axial compression in the force stack is therefore not compromised, while the divergent forces are at least partially absorbed by the material 51 and O-rings 53. The proximal end of the limited rotation motor system may similarly include cross-sectionally L-shaped elastomeric material (e.g., 1) and O-rings 53 mounted similarly.

The positions of the compression thrust washers and compression O-rings are moved to the outer sides of the bearings. The limited rotation motor system includes a rotor 18 within a stator 14 inside a housing 16. Again, the system includes the compliant thrust washer and compression O-rings (e.g., three each) between the rotor end caps and the housing on the outer sides of the bearing systems. The divergent forces (F_{d}) diverging from the axial direction are similarly absorbed by the compliant thrust washers as well as the one or more compliant radial members such as compliant O-rings.

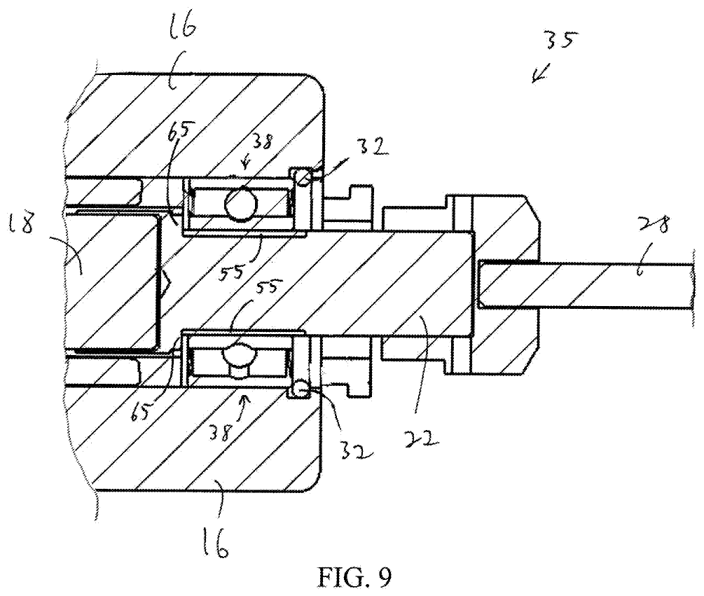

FIG. 9 shows a distal end 35 of a limited rotation motor system in accordance with a further aspect that includes an annular elastomeric material 55 that is bonded to an inner surface of the inner race of the bearing system. The bonding for example, may be provided by a silicon room temperature vulcanization (RTV) adhesive. The limited rotation motor system similarly includes the rotor 12 with the stator 14 inside the housing 16. The rotor includes the magnet 18 contained between proximal and distal end caps (distal end cap 22 is shown), with the mirror 28 mounted thereto. The elastomeric material 55 is radially offset from the central region of the end cap against which the compressive force (F_{c}) is provided. The axial compression in the force stack is again therefore not compromised, while the divergent forces are also at least partially absorbed by the elastomeric material 55, which provides axial and radial absorption. The elastomeric material 55 is also mounted against an axial shoulder 65 of the distal end cap 22. Again, although the shoulder 65 is provided in the axial direction, it is radially offset from the central region of the end cap 22 against which the compressive force (F_{c}) is provided. The elastomeric material is provided on an inner surface of the bearing system 38. The axial compression in the force stack is therefore not compromised, while the divergent forces are at least partially absorbed by the elastomeric material 55. The proximal end of the limited rotation motor system may similarly include elastomeric material (e.g., 55) against a shoulder on the proximal end cap and bonded to the proximal bearing system.

The elastomeric material 55 is bonded between the inner race of the bearing and the shaft. The area near the shoulder 65 does not have elastomer (in compression) taking up axial force. The material 55 is adhered to both the inner race of the bearing and the outer surface of the shaft. The bonding strength of this material should have sufficient strength to withstand the shearing force of the axial directed pre-load force.

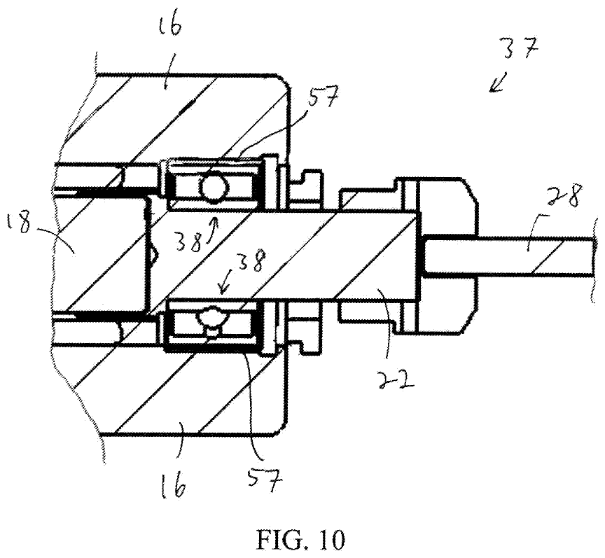

FIG. 10 shows a distal end 35 of a limited rotation motor system in accordance with a further aspect that includes an annular elastomeric material 57 that is bonded to an outer surface of the inner race of the bearing system. The bonding for example, may be provided by a silicon room temperature vulcanization (RTV) adhesive. The limited rotation motor system similarly includes the rotor 12 with the stator 14 inside the housing 16. The rotor includes the magnet 18 contained between proximal and distal end caps (distal end cap 22 is shown), with the mirror 28 mounted thereto. The elastomeric material 57 is radially offset from the central region of the end cap against which the compressive force (F_{c}) is provided. The axial compression in the force stack is again therefore not compromised, while the divergent forces are also at least partially absorbed by the elastomeric material 57, which provides axial and radial absorption. The axial compression in the force stack is therefore not compromised, while the divergent forces are at least partially absorbed by the elastomeric material 57. The proximal end of the limited rotation motor system may similarly include elastomeric material (e.g., similar to 57) mounted at the proximal end.

Retaining rings (again having circular or polygonal cross-sectional shapes) may be used with the above systems, although with the systems that include the annular elastomeric material that is bonded in place, retaining rings may not be required. With reference again to FIGS. 1 and 4, limited rotation motor systems in accordance with various aspects of the present invention may include any combination of the above damping elements as part of dynamic damping systems, for example, with proximal and distal ends including different combinations of O-rings (axial and radial), thrust washers, cross-sectionally L-shaped material and annular elastomeric material, both mounted radially inwardly or outwardly.

Again, each of the elastomeric features discussed above may be provided on any or both of the proximal and distal ends of limited rotation motor systems in accordance with various aspects of the present invention. The elastomeric features may be molded parts that are installed, or formed in place between the shaft and bearing, or an over-molded features on the surface of the shaft or the inner surface of the housing.

What is claimed is:

1. A limited rotation motor system comprising:
a stator within a housing;
a rotor rotatably coupled within the stator by a first bearing system at a proximal end and a second bearing system at a distal end, each of said first bearing system and said second bearing system being coupled at an inner side thereof to the rotor and being coupled at an outer side thereof to the housing;
a compression system applying a compressive force between the first bearing system and the second bearing system in an axial direction; and
a damping system adjacent any of the first bearing system and the second bearing system, said damping system providing that divergent forces resulting from the compressive force that diverge from the axial direction are absorbed by the damping system.

2. The limited rotation motor system as claimed in claim 1, wherein the damping system includes an elastomeric washer positioned between the rotor and any of the first bearing system and the second bearing system.

3. The limited rotation motor system as claimed in claim 2, wherein the elastomeric washer is positioned between a shoulder on the rotor and an inner race of any of the first bearing system and the second bearing system.

4. The limited rotation motor system as claimed in claim 1, wherein the damping system includes an elastomeric washer positioned between the housing and any of the first bearing system and the second bearing system.

5. The limited rotation motor system as claimed in claim 1, wherein the damping system includes at least one O-ring positioned between the rotor and any of the first bearing system and the second bearing system.

6. The limited rotation motor system as claimed in claim 5, wherein the at least one O-ring is compressed.

7. The limited rotation motor system as claimed in claim 1, wherein the damping system includes at least one O-ring positioned between the housing and any of the first bearing system and the second bearing system.

8. The limited rotation motor system as claimed in claim 1, wherein the damping system includes a plurality of O-rings adjacent any of the first bearing system and the second bearing system.

9. The limited rotation motor system as claimed in claim 1, wherein the damping system includes a cross-sectionally L-shaped elastomeric material positioned between the rotor and any of the first bearing system and the second bearing system.

10. The limited rotation motor system as claimed in claim 1, wherein the damping system includes a cross-sectionally L-shaped elastomeric material positioned between the housing and any of the first bearing system and the second bearing system.

11. The limited rotation motor system as claimed in claim 1, wherein the damping system includes an annular elastomeric material positioned between the rotor and any of the first bearing system and the second bearing system.

12. The limited rotation motor system as claimed in claim 1, wherein the damping system includes an annular elastomeric material positioned between the housing and any of the first bearing system and the second bearing system.

13. The limited rotation motor system as claimed in claim 1, wherein the compressive force is provided by a spring against a retaining ring.

14. The limited rotation motor system as claimed in claim 13, wherein the compressive force is provided by the spring at the distal end of the first bearing system against the retaining ring against the second bearing system.

15. The limited rotation motor system as claimed in claim 1, wherein the damping system includes elastomeric material that is any of molded parts installed, or formed in place, or over-molded feature on the surface of other components of the system.

16. A limited rotation motor system comprising:
a stator within a housing;
a rotor rotatably coupled within the stator by a first bearing system at a proximal end and a second bearing system at a distal end, each of said first bearing system and said second bearing system being coupled at an inner side thereof to the rotor and being coupled at an outer side thereof to the housing;
a compression system applying a compressive force between the first bearing system and the second bearing system in an axial direction; and
a damping system between the rotor and the housing and providing that divergent forces resulting from the compressive force that diverge from the axial direction are absorbed by the damping system.

17. The limited rotation motor system as claimed in claim 16, wherein the damping system includes an elastomeric washer positioned between the rotor and any of the first bearing system and the second bearing system.

18. The limited rotation motor system as claimed in claim 17, wherein the elastomeric washer is positioned between a shoulder on the rotor and an inner race of any of the first bearing system and the second bearing system.

19. The limited rotation motor system as claimed in claim 16, wherein the damping system includes an elastomeric washer positioned between the housing and any of the first bearing system and the second bearing system.

20. The limited rotation motor system as claimed in claim 16, wherein the damping system includes at least one O-ring positioned between the rotor and any of the first bearing system and the second bearing system.

21. The limited rotation motor system as claimed in claim 20, wherein the at least one O-ring is compressed.

22. The limited rotation motor system as claimed in claim 16, wherein the damping system includes at least one O-ring positioned between the housing and any of the first bearing system and the second bearing system.

23. The limited rotation motor system as claimed in claim 16, wherein the damping system includes a plurality of O-rings adjacent any of the first bearing system and the second bearing system.

24. The limited rotation motor system as claimed in claim 16, wherein the damping system includes a cross-sectionally L-shaped elastomeric material positioned between the rotor and any of the first bearing system and the second bearing system.

25. The limited rotation motor system as claimed in claim 16, wherein the damping system includes a cross-sectionally L-shaped elastomeric material positioned between the housing and any of the first bearing system and the second bearing system.

26. The limited rotation motor system as claimed in claim 16, wherein the damping system includes an annular elastomeric material positioned between the rotor and any of the first bearing system and the second bearing system.

27. The limited rotation motor system as claimed in claim 16, wherein the damping system includes an annular elastomeric material positioned between the housing and any of the first bearing system and the second bearing system.

28. The limited rotation motor system as claimed in claim 16, wherein the compressive force is provided by a spring against a retaining ring.

29. The limited rotation motor system as claimed in claim 28, wherein the compressive force is provided by the spring at the distal end of the first bearing system against the retaining ring against the second bearing system.

30. The limited rotation motor system as claimed in claim 16, wherein the damping system includes elastomeric material that is any of molded parts installed, or formed in place, or over-molded feature on the surface of other components of the system.

31. A method of operating a limited rotation motor, said method comprising:
providing a stator within a housing;
providing a rotor rotatably coupled within the stator by a first bearing system at a proximal end and a second bearing system at a distal end, each of said first bearing system and said second bearing system being coupled at an inner side thereof to the rotor and being coupled at an outer side thereof to the housing;
applying a compressive force between the first bearing system and the second bearing system in an axial direction; and
damping divergent forces resulting from the compressive force that diverge from the axial direction by absorbing the divergent forces with an elastomeric component between the rotor and the housing.

32. The method as claimed in claim 31, wherein the elastomeric component includes any of an O-ring, a compliant washer, a cross-sectionally L-shaped elastomeric material, and an annular elastomeric material.
